(19) United States
(12) Patent Application Publication
(10) Pub. No.: US 2009/0112847 A1
(43) Pub. Date: Apr. 30, 2009

(54) APPARATUS AND METHOD FOR ENHANCING A COMPOSITION WITH RELEVANT CONTENT POINTERS

(75) Inventors: Morris SIM, San Mateo, CA (US); George MITCHELL, Marina Del Rey, CA (US); Mario JOBBE, San Francisco, CA (US)

Correspondence Address: COOLEY GODWARD KRONISH LLP;ATTN: Patent Group, Suite 1100, 777 - 6th Street, NW, Washington, DC, 20001, US

(73) Assignee: CIRCOS.COM, INC., San Mateo, CA (US)

(21) Appl. No.: 11/933,089

(22) Filed: Oct. 31, 2007

(51) Int. Cl. G06F 7/00

(52) U.S. Cl. 707/5

(57) ABSTRACT

A computer readable medium includes executable instructions to identify a pre-existing list of keyphrases, to compare a keyphrase in a composition to the pre-existing list of keyphrases to obtain at least one candidate content pointer, and to associate the keyphrase with a content pointer selected from the at least one candidate content pointer.

### FIELD OF THE INVENTION

The present invention relates generally to content enhancement. More particularly, this invention relates to enhancing a composition by associating phrases within the composition with relevant content pointers.

### BACKGROUND OF THE INVENTION

As the Internet has matured, the content available online has proliferated. Internet users have access to a huge supply and variety of content including text, music, video, and images. Users can leverage this content to enrich their own communication. For example, a person discussing restaurants in an electronic mail (email) composition to a friend can attach personal content to the email that describes her favorite restaurants, or can attach content obtained from third parties via content sharing. The email composer can also perform an Internet search to obtain hyperlinks, such as Uniform Resource Locators (URLs), to the website of each of her favorite restaurants and manually insert these links into the email composition. However, to determine the relevance of content to a composition, the composer typically needs to review the content and perform a comparison to the composition.

The growth of Internet use has also created a large market for targeted web advertising. Advertisers leverage software systems that analyze content, such as email compositions, to determine targeted advertisements that are relevant to, for example, topics discussed in the composition. One common method to deliver these targeted advertisements is to display advertising banners at render time, which is when the recipient opens the composition. In this method, the advertisements appear alongside the composition, and the content of the advertisement is separate from the content of the composition. The composer typically does not have knowledge that a specific advertisement is being shown to the recipient at render time. Part of the reason for displaying advertisements at render time rather than at compose time may be that the typical composer does not have a large readership, and therefore has generally been unable to generate advertising revenue from his personal network by sending advertising content to that network.

Although targeted web advertising is becoming widespread, the effectiveness of the advertising may be limited. For example, advertisements that appear alongside a composition, though often related to the general subject matter of the composition, are typically not integrated with the content of the composition. A recipient of the composition may therefore be less likely to notice or pay attention to the advertisements because the recipient may be focused on the content of the composition.

It would be desirable to provide to a composer content that is relevant to his composition without requiring review of the content by the composer. As part of this solution, it would be advantageous to determine a basis for automatically comparing the content to the composition, and for quantifying the relevance of each piece of content to each portion of the composition. Based on this comparison, it would also be desirable to associate a reference to specific content with a specific portion of the composition. Also based on this comparison, it would be advantageous to enable a composer to associate a wide range of content, including advertising content, with portions of the composition.

### SUMMARY OF THE INVENTION

This invention includes a computer readable medium with executable instructions to identify a pre-existing list of keyphrases, to compare a keyphrase in a composition to the pre-existing list of keyphrases to obtain at least one candidate content pointer, and to associate the keyphrase with a content pointer selected from the at least one candidate content pointer.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a system for enhancing a composition with relevant content pointers, in accordance with one embodiment of the present invention;

FIG. 2 illustrates operations associated with enhancing a composition with relevant content pointers, in accordance with one embodiment of the present invention;

FIG. 3 illustrates an example of a graphical toolbar for accessing a system for enhancing a composition with relevant content pointers, in accordance with one embodiment of the present invention,

FIG. 4 illustrates an example of a graphical user interface showing candidate content pointers corresponding to a keyphrase in a composition, in accordance with one embodiment of the present invention; and

FIG. 5 illustrates an example of a graphical user interface showing a composition including a keyphrase with an associated relevant content pointer.

### DETAILED DESCRIPTION OF THE INVENTION

To determine content that is relevant to a composition without requiring review of the content by the composer, a basis is needed for automatically comparing the content to the composition. In one embodiment, this basis includes a list of keyphrases identified from a collection of content, where a keyphrase is a significant phrase associated with the content that may be used as an index to the content.

One approach to identifying keyphrases from content may include extracting keyphrases from content associated with at least one content pointer. A content pointer is a reference to content. Examples of content pointers include hyperlinks to content accessible on the Internet and icons representing locally stored content. These icons may include a thumbnail image and an icon representing content such as a video clip, an audio file, or a document.

After identification of the pre-existing list of keyphrases, this list may be compared to a composition. As used herein, a composition is an electronic document with text, such as an email, word processing document, web page, and the like. In one embodiment, the pre-existing list of keyphrases is compared to the composition to determine if keyphrases from the list, including word stems of keyphrases from the list, are present in the composition. If a match is found, then the keyphrase found in the composition may correspond to at least one candidate content pointer. In this embodiment, a candidate content pointer is a content pointer that can be used to access content associated with a keyphrase from the pre-existing list, which matches the keyphrase found in the composition. There may be more than one candidate content pointer that corresponds to a keyphrase found in the composition, as there may be more than one relevant piece of content associated with that keyphrase.

The keyphrase in the composition may then be associated with a content pointer selected from the at least one candidate content pointer. This association may enable a context-sensitive integration of the content pointer with the keyphrase. For example, the appearance of the keyphrase displayed in the composition may be modified, including highlighted, underlined, given a different color, to indicate that there is a content pointer associated with the keyphrase. A user may then be able to access the content corresponding to the content pointer by, for example, performing a mouse click on the keyphrase.

Users, including composers, may find the above features to be attractive. The collection of content available to users can be wide-ranging. For example, the content may include content created by the user, recommended content, and advertiser-created content. The context-sensitive integration of keyphrases in a composition to pointers to relevant pieces of content can enable richer electronic communication, and increase the effectiveness of targeted web advertising. The capability to automatically compare pre-existing keyphrases extracted from content to a composition can enable this integration without requiring review of content by the user. It may then be possible for composers to derive revenue from the automatic integration of relevant advertising content into their compositions.

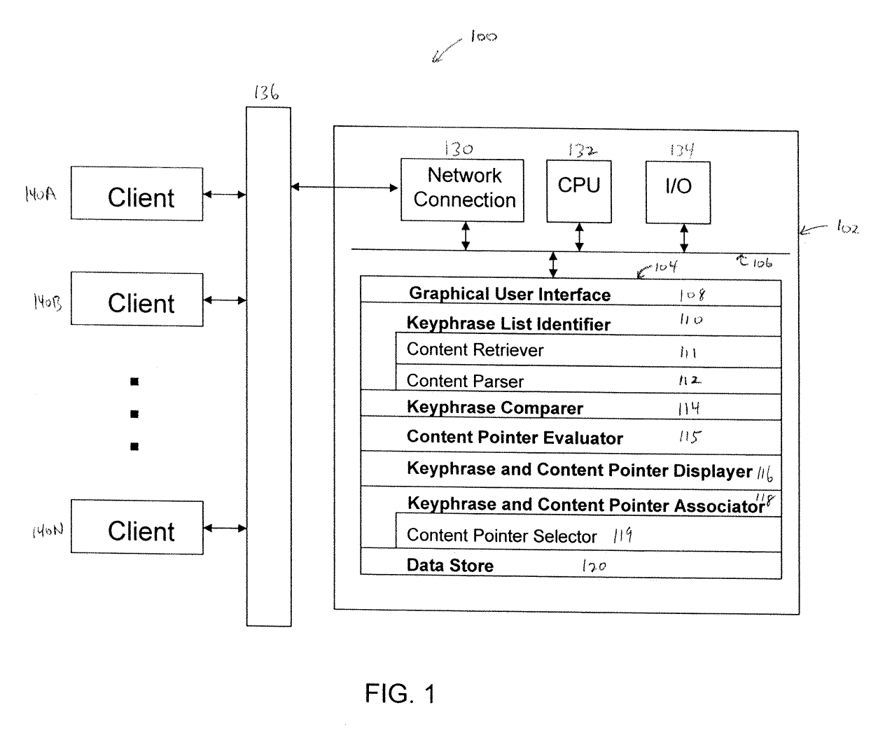

FIG. 1 illustrates a system 100 for enhancing a composition with relevant content pointers, in accordance with one embodiment of the present invention. The system 100 includes a transmission channel 136 connecting a computer 102 with clients 140A-140N. The computer 102 includes standard components, such as a network connection 130, a CPU 132, and input/output devices 134, which communicate over a bus 106. A memory 104 is also connected to the bus 106. The memory 104 stores a set of executable programs that are used to implement functions of the invention. The clients 140 typically include the same standard components.

In an embodiment of the invention, the memory 104 includes executable instructions establishing a graphical user interface 108, a keyphrase list identifier 110, a keyphrase comparer 114, a content pointer evaluator 115, a keyphrase and content pointer displayer 116, a keyphrase and content pointer associator 118, and a data store module 120. The keyphrase list identifier 110 may include a content retriever 111 and a content parser 112. The keyphrase and content pointer associator 118 may include a content pointer selector 119. The data store module 120 may read data from and write data to memory or to internal or external data sources, such as databases. The modules in memory 104 are exemplary. The function of individual modules may be combined. In addition, the modules may be distributed across a network. It is the processing associated with the invention that is significant, not where or how the processing is implemented.

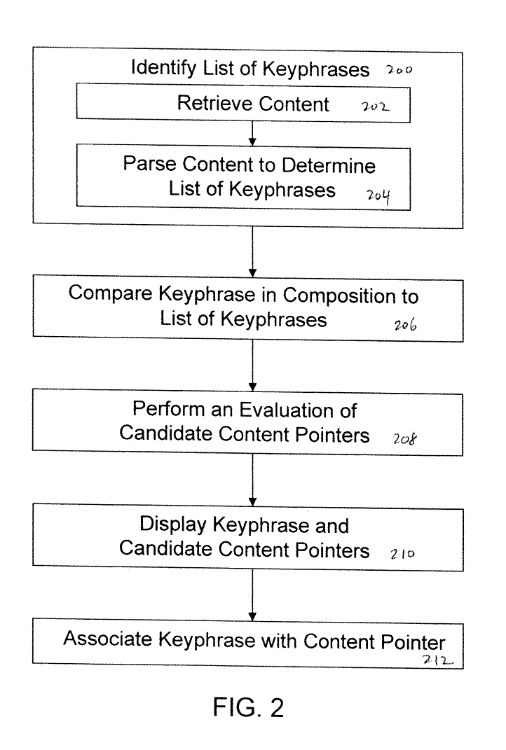

FIG. 2 illustrates operations associated with enhancing a composition with relevant content pointers, in accordance with one embodiment of the present invention. The keyphrase list identifier 110 identifies a list of keyphrases from a collection of content (block 200). The identification of keyphrases may take place as content is added to the collection, so that there is a pre-existing list of keyphrases available to apply to a composition. The content may be collected in a content repository that may be generic or personalized to a particular user. The content repository may contain content that a user has created, recommended content, or content that has been created by advertisers or other third parties. Recommended content may include content recommended by a user, content recommended by a user's social network, content recommended by the system, and content recommended by a third party.

In one embodiment, the keyphrase list identifier 110 may retrieve content (block 202). The keyphrase list identifier 110 may crawl pre-defined data sources including data sources accessible using Uniform Resource Locators (URLs), web services and Extensible Markup Language (XML) tags. The content obtained through crawling may be written into memory or inserted into internal or external data sources, such as databases, by data store module 120. The user may also add a URL into the system. When the URL is added, the system may check to see if the URL has already been crawled and if not, may crawl it in real time.

In one embodiment, the keyphrase list identifier 110 may parse content to determine the list of keyphrases (block 204). After the raw content is retrieved, the keyphrase list identifier 110 may parse the content to extract the most useful keyphrases from the content. In the case of locally stored content such as video or images, the keyphrases may be extracted from text tied to the content. The most useful keyphrases may be keyphrases that best represent the content, based on a relevance criterion. The relevance criterion may be based on a weighted combination of at least one of metatags associated with the content such as Hypertext Markup Language (HTML) metatags and frequency count of individual words in the content. The frequency count of individual words may be obtained using a stemming algorithm, which is a way of extracting a common root from English words. For example, the words “runs”, “running”, and “runneth” have the common stem “run”. One example of a stemming algorithm is the Porter stemmer algorithm. Using a stemming algorithm, the frequency count of individual words includes all words that share a common root with any of the individual words.

The keyphrases extracted from content by the keyphrase list identifier 110 may include nested keyphrases. For example, content containing “Paris Hilton Hotels” may return the six combinations of one or more words within the phrase, namely: “Paris”, “Hilton”, “Hotels”, “Paris Hilton”, “Hilton Hotels”, and “Paris Hilton Hotels”.

Users and advertisers may also directly associate keyphrases with content. For example, a user may manually enter a keyphrase and associate the keyphrase with content, or an advertiser may purchase a keyphrase and request that the keyphrase be associated with content. The keyphrase may be user-defined or advertiser-defined. This association, along with the addition of the keyphrase to the list of keyphrases, may be performed by the keyphrase list identifier 110. The input may be provided using the graphical user interface 108 or a command line interface to the computer 102, or using a similar interface to the client 140.

The keyphrase comparer 114 then compares the composition to the list of keyphrases to determine if there are matching keyphrases in the composition (block 206). These keyphrases correspond to candidate content pointers. In one embodiment, the keyphrase comparer 114 finds a match between keyphrases if the stems of each word in each keyphrase match. The keyphrase comparer 114 may be a dedicated process accessible via TCP/IP (Transmission Control Protocol/Internet Protocol) or web services that takes the composition as input and returns matching keyphrases. In one embodiment, the keyphrase comparer 114 may index all keyphrases extracted from content by the keyphrase list identifier 110 into a custom in-memory search tree. This search tree may have specially defined structures so that search results are returned in O(1) time with a small memory footprint. One way of achieving an O(1) search is to use a many-level search tree so that each word can be searched incrementally, with no database lookups.

The content pointer evaluator 115 then optionally performs an evaluation of candidate content pointers (block 208). In one embodiment, this evaluation may be performed to rank candidate content pointers so that the candidate content pointers may be displayed to the user in order of relevance (see block 210). This evaluation may be based on criteria including at least one of a rating of the content referenced by the content pointer, a rating of the provider of the content, an advertiser price associated with the content, and user composition preferences. The evaluation may include ranking the content pointers that can be associated with a keyphrase based on a weighted combination of the above criteria. The rating of the provider of the content may be based on whether the provider is in the user's social network, in which case the provider may get a higher score. The rating of the provider may also be increased based on the influence of the provider. Provider influence may be measured using metrics such as the number of people in the provider's social network and the speed of provider response to online requests. The advertiser price associated with the content may be the price offered by the advertiser to embed a candidate content pointer into the composition, or the price offered by the advertiser for each click on an embedded content pointer in the composition. User composition preferences may include user preferences for associating content that is popular and/or profitable with a user composition.

The keyphrase and content pointer displayer 116 then optionally displays the keyphrase and the corresponding candidate content pointers (block 210). In one embodiment, the purpose of this display may be to enable the user to see the candidate content pointers corresponding to a keyphrase in a composition. The user may then, for example, choose a candidate content pointer to associate with the keyphrase (see block 212), or may allow one of the candidate content pointers to be associated with the keyphrase automatically (see block 212). The display of the candidate content pointers may be ordered based on the evaluation of the candidate content pointers.

The keyphrase and content pointer associator 118 then associates the keyphrase with a content pointer selected from the candidate content pointers (block 212). The appearance of the keyphrase may be modified to indicate an association with the content pointer. The selection of the content pointer may be performed by the content pointer selector 119, which enables the user to skip the process of selecting specific content pointers. The content pointer selector 119 may automatically select links based on various criteria, including most popular, most profitable, and least well-known.

The selection may also be performed by the user via input to the graphical user interface 108, a command line interface, or input to the client 140. In one embodiment, the user may specify the content pointer to associate with a keyphrase in the composition, and may optionally also specify the keyphrase. In another embodiment, the user may specify the preferred algorithm to be used by the content pointer selector 119 to determine the content pointer to associate with the keyphrase. The user command may be specified using double punctuation syntax, which enables the user to bracket words and phrases and identify them for link replacement. Table 1 shows the syntax and corresponding preferential algorithms.

TABLE 1
Double punctuation syntax and corresponding preferential algorithms.

| Syntax | Preferential Algorithm |
|---|---|
| -#word#- | Most relevant, non-monetizable links generated by me |
| -$word$- | Most profitable link generated by me |
| -n#word#n- | Most relevant, non-monetizable links generated by my |
| | network |
| -n$word$n- | Most profitable links generated by my network |
| -g#word#g- | Most relevant, non-monetizable links from my groups |
| -g$word$g- | Most profitable links from my groups |
| -[My group name]#word#g- | Most relevant non-monetizable links only from a specific |
| | [my group name] |
| -[My group name]$word$g- | Most profitable links only from a specific [my group name] |
| -c#word#c- | Most relevant links from my communities |
| -c$word$c- | Most profitable links from my communities |
| -[My community name]#word#c- | Most relevant links from a specific [my community name] |
| -[My community name]$word$c- | Most profitable links from a specific [my community name] |
| -a#word#a- | Most relevant link from the entire web site network |
| -a$word$a- | Most profitable links from the entire web site network |
| Special Construction | Meaning |
| [vertical tag a] [AND] [vertical tag b], . . . [tag n]:[tag 1], | The : (colon) separator is shorthand to scope search |
| [AND] [tag2], . . . [tag n]:: [all], [AND] [c], [community name], | vertically. Tags before the colon are treated as absolute |
| [g], [group name], [n] , [m] | musts (filters), and are a default OR condition unless users |
| | specify the optional AND. |
| | Tags after the colon denote what is being looked for with |
| | the filters, and the specific tag and their associated |
| | supertags (or ontological parent terms) are searched. |
| | Default behavior is OR unless AND is specified. |
| | The :: (double colon separator) further specifies scope by |
| | allowing users to limit the answer set to be from the |
| | different user entities that exist in the Linker system. The |
| | default behavior is OR, if unspecified, the default scope is |
| | Me OR My Network OR My Group OR My Community |

It is possible for users to replace any of the tags in the special construction at the bottom of Table 1 with any of the syntaxes in the first section of Table 1. The following is an example of acceptable syntax:
-a#red wine#a- AND -c#France#c-:award::Bay Area Wine Club n

The above syntax would return all URLs that are marked “Red Wine” on the entire network and by the France community that have the tag “award” associated with it (and “award'”s supertags) in either the Bay Area Wine Club or in the user's own social network. In layman's terms, the person is looking for award-winning red wines recognized by the French Community that his network and the group he belongs to have recommended.

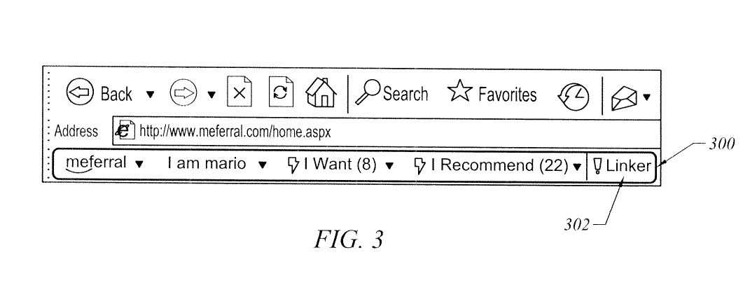

FIG. 3 illustrates an example of a graphical toolbar 300 for accessing a system 100 for enhancing a composition with relevant content pointers, in accordance with one embodiment of the present invention. The toolbar 300 may include a button 302 that may be used to activate executable instructions to compare a composition to a pre-existing list of keyphrases and subsequent instructions (see blocks 206-212). The executable instructions to compare may be activated by the toolbar 300 from a supported composition website, or from a website such as http://www.meferral.com/ that can directly activate the executable instructions in memory 104. The toolbar 300 may automatically detect whether a user has navigated to a supported composition website, and may support multiple composition websites.

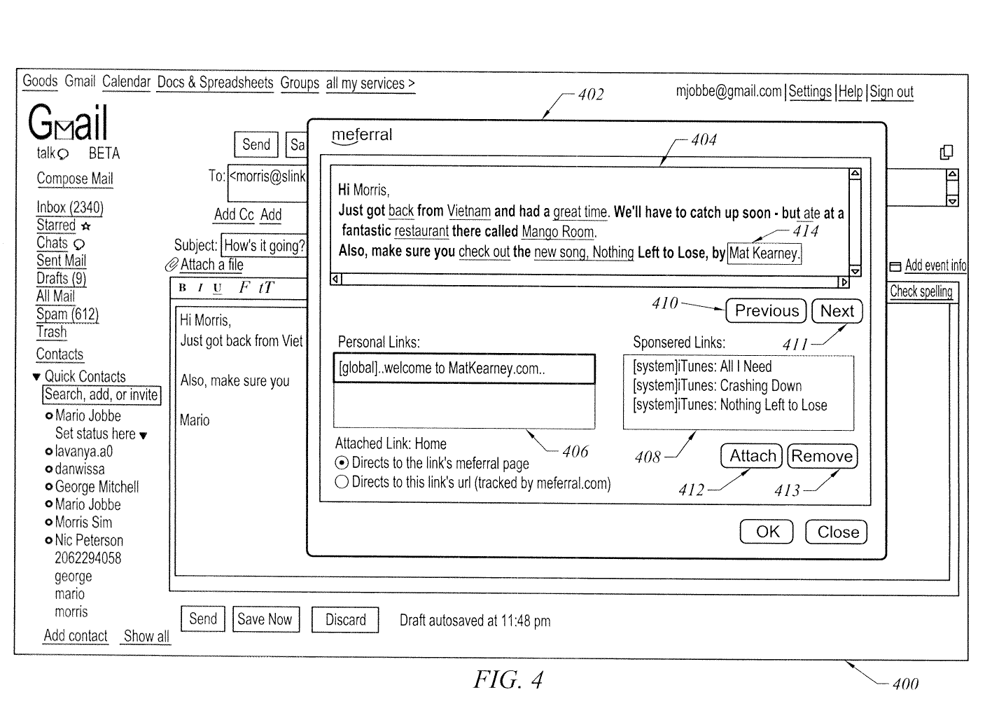

FIG. 4 illustrates an example of a graphical user interface 402 showing candidate content pointers corresponding to a keyphrase 414 in a composition shown in window 404, in accordance with one embodiment of the present invention. In this embodiment, the composition shown in window 404 is obtained from the email composition shown in email composition window 400. The keyphrases determined by the comparison of the composition to the list of keyphrases (block 206) are shown as underlined and in a different color in window 404. The user can then choose whether to replace each underlined keyphrase with a candidate content pointer. In this example, the candidate content pointers are shown in personal hyperlinks panel 406 and sponsored hyperlinks panel 408. The user can select a content pointer from the candidate content pointers for the keyphrase 414 using the “Attach” button 412, and can deselect a selected content pointer using the “Remove” button 413. The user can then proceed to the previous or next keyphrase using the “Previous” button 410 and the “Next” button 411.

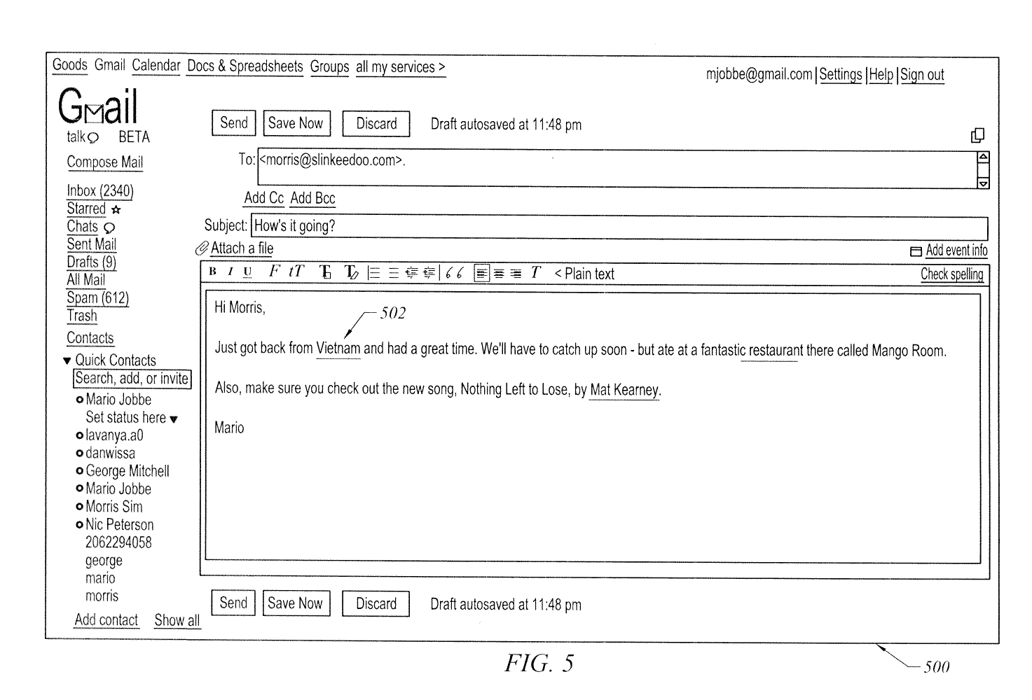

FIG. 5 illustrates an example of a graphical user interface 500 showing a composition including a keyphrase 502 with an associated relevant content pointer. The keyphrase 502 “Vietnam”, which is associated with a content pointer, has a different appearance from the keyphrase “Vietnam” as shown in the window 400, before association with a content pointer. In this embodiment, the keyphrase 502 “Vietnam” is underlined, unlike “Vietnam” as shown in the window 400. Activating the keyphrase, for example by mouse action, may automatically invoke related content. Alternately, related content may be displayed for selection.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A computer readable medium, comprising executable instructions to:
identify a pre-existing list of keyphrases;
compare a keyphrase in a composition to the pre-existing list of keyphrases to obtain at least one candidate content pointer; and
associate the keyphrase with a content pointer selected from the at least one candidate content pointer.

2. The computer readable medium of claim 1, wherein the content pointer is a hyperlink.

3. The computer readable medium of claim 1, wherein the content pointer is an icon representing locally stored content.

4. The computer readable medium of claim 1, wherein the executable instructions to identify include executable instructions to extract the pre-existing list of keyphrases from content associated with at least one content pointer.

5. The computer readable medium of claim 4, wherein the content is included in a content repository that includes at least one of content created by a user of the repository, recommended content, and content created by an advertiser.

6. The computer readable medium of claim 4, further comprising executable instructions to retrieve the content by crawling pre-defined data sources.

7. The computer readable medium of claim 6, wherein the pre-defined data sources include at least one of data sources accessible using Uniform Resource Locators (URLs), web services, and extensible markup language (XML) tags.

8. The computer readable medium of claim 4, wherein the executable instructions to extract include executable instructions to parse the content to determine the pre-existing list of keyphrases.

9. The computer readable medium of claim 8, wherein the pre-existing list of keyphrases includes nested keyphrases.

10. The computer readable medium of claim 8, wherein the executable instructions to parse include executable instructions to evaluate potential keyphrases for inclusion in the pre-existing list of keyphrases based on at least one of metatags associated with the content and frequency count of individual words within the content.

11. The computer readable medium of claim 1, wherein the pre-existing list of keyphrases includes at least one of a user-defined keyphrase and an advertiser-defined keyphrase.

12. The computer readable medium of claim 1, wherein the executable instructions to compare are activated by input provided via a graphical user interface.

13. The computer readable medium of claim 1, wherein the executable instructions to associate are based on user preferences.

14. The computer readable medium of claim 1, wherein the executable instructions to associate include executable instructions to select the content pointer based on at least one of relevance, profitability, and source.

15. The computer readable medium of claim 1, wherein the executable instructions to associate are initiated by a command using double punctuation syntax.

16. The computer readable medium of claim 1, wherein the executable instructions to associate include executable instructions to select the content pointer based on input provided via a graphical user interface.

17. The computer readable medium of claim 1, further comprising executable instructions to display the keyphrase and the at least one candidate content pointer.

18. The computer readable medium of claim 17, further comprising executable instructions to perform an evaluation of the at least one candidate content pointer based on at least one of a rating of the content, a rating of the provider of the content, an advertiser price associated with the content, and user composition preferences.

19. The computer readable medium of claim 18, wherein the executable instructions to display include executable instructions to order the display of the at least one candidate content pointer based on the evaluation.

20. The computer readable medium of claim 1, wherein the executable instructions to associate include executable instructions to modify the appearance of the keyphrase to indicate an association with the content pointer.
